(19) United States
(12) Patent Application Publication
(10) Pub. No.: US 2023/0030508 A1
(43) Pub. Date: Feb. 2, 2023

(54) PHOTOVOLTAIC MODULE SUPPORT SYSTEM

(71) Applicant: Lumos Solar, LLC, Lafayette, CO (US)

(72) Inventors: Brian RAFFERTY, Lafayette, CO (US); Dinesh Goundla, Boulder, CO (US); Keith Yzquierdo, Nederland, CO (US); Scott Franklin, Nederland, CO (US)

(73) Assignee: Lumos Solar, LLC, Lafayette, CO (US)

(21) Appl. No.: 17/879,519

(22) Filed: Aug. 2, 2022

Related U.S. Application Data
(60) Provisional application No. 63/228,311, filed on Aug. 2, 2021.

(51) Int. Cl. H02S 30/10; F16M 11/04

(52) U.S. Cl. CPC H02S 30/10; F16M 11/04

(57) ABSTRACT

A photovoltaic (“PV”) module support system including a first PV module having a first PV panel adapted to generate electrical energy from sunlight. The first PV panel has an upper surface and a lower surface and a first frame secured to the lower surface of the first PV panel. The first frame having a pair of first frame members including an elongate slot. A first joining rail has a body and a first wall projecting outwardly from the body. The first wall is inserted within the elongate slot of one of the pair of the first frame members. A fastener is connected to the one of the pair of first frame members and movable to clamp the wall within the slot, wherein the first PV module is positionally fixed relative to the joining rail.

This application claims the benefit of priority to U.S. Provisional Patent Application No. 63/228,311 filed Aug. 2, 2021, the contents of which are incorporated by reference herein for all purposes.

### FIELD OF TECHNOLOGY

The disclosure is directed to a system for supporting panels such as photovoltaic (“PV”) modules, and more particularly to a system for permitting PV modules to be supported and to facilitate installation and adjustment of the PV modules.

### BACKGROUND

Photovoltaic (“PV”) modules, also known as solar modules, are well known in the art for converting solar energy into electrical energy. As the desirability for clean and efficient energy sources increases, so does the desire to use power sources such as PV modules.

PV modules may be mounted on a structure, such as a roof of a house or building where they are readily exposed to sunlight. Alternatively, PV modules themselves may form the roof, awning or covering of a structure. Since the modules are exposed to the environment, they need to be properly secured to the structure so they can withstand winds and other environmental effects. Photovoltaic modules are typically secured to structures by way of elongated rails secured to the structure. It is known to use various clamps and hardware which are securable by a threaded bolt and nut to an elongated rail. The clamps may be positioned to engage and secure the PV modules.

The prior art support systems for PV modules typically include a number of clamps, brackets, fasteners and rails which make it difficult to assemble and properly align the PV modules in an array. In addition, if a particular module in an array needs to be replaced, the surrounding PV modules would need to be removed or disturbed. This requires readjusting the position of the various modules.

Accordingly, it would be desirable to provide a system and method for securing PV modules that permits ease of assembly and adjustment.

### SUMMARY

The present disclosure provides a photovoltaic (“PV”) module support system including a first PV module having a first PV panel adapted to generate electrical energy from sunlight. The first PV panel has an upper surface and a lower surface and a first frame secured to the lower surface of the first PV panel. The first frame has a pair of first frame members each including an elongate slot. A first joining rail has a body and a first wall projecting outwardly from the body. The first wall is inserted within the elongate slot of one of the pair of the first frame members. A fastener is connected to the one of the pair of first frame members and movable to clamp the wall within the slot, wherein the first PV module is positionally fixed relative to the joining rail.

The present disclosure also provides a photovoltaic (“PV”) module array including a first and second PV modules including a PV panel for generating electricity and a frame secured to an undersurface thereof. The frame of the first and a second PV module includes a slot extending along a portion thereof. An elongate first joining rail secures the plurality of PV modules together. The first joining rail includes a pair of spaced walls extending along a length thereof. A first of the pair of walls is inserted in a slot in the frame of a first PV module and the second of the pair of walls is inserted in a slot in the frame of a second PV module. The first and second PV modules are slidable on the joining rail in an unsecured state. A plurality of fasteners are engageable with the frame and the joining rail. The plurality of fasteners being movable to a securing position to secure the first and second PV modules relative to the joining rail wherein the position of the first and second PV modules are fixed.

The present disclosure further provides a method of installing a photovoltaic (“PV”) module array including, obtaining a plurality of PV modules each including an electricity producing PV panel having a frame secured to an underside thereof;
obtaining a joining rail having a first and second spaced walls projecting outwardly from a rail;
sliding a first of the plurality of PV modules onto the first wall of the joining rail and sliding a second of the plurality of PV modules onto the second wall of the joining rail;
operating a first fastener disposed on the first PV module frame to clamp the joining rail first wall to the frame wherein the position of the first PV module is fixed; and
operating a second fastener disposed on the second PV module frame to clamp the joining rail second wall to the frame wherein the position of the second PV module is fixed.

The present disclosure still further provides a panel joining and support system including a first panel having an upper surface and a lower surface. A frame is secured to the lower surface of the first panel. The frame has a first frame member including an elongate slot running along a length of the first frame member. A joining rail has a body and a first wall projecting outwardly from the body. The first wall is inserted within the elongate slot of the first member. A fastener is connected to the first frame member and movable to clamp the wall within the slot, wherein the first panel is positionally fixed relative to the joining rail.

### BRIEF DESCRIPTION OF DRAWINGS

FIG. 1A is top perspective view of a PV module support system showing an array of connected PV modules.

FIG. 1B is bottom perspective view of the PV module support system of FIG. 1A.

FIG. 1C is bottom perspective view of the PV module support system showing an alternative embodiment of the PV modules.

FIG. 1D is an exploded elevational view of the PV module support system of FIG. 1C.

FIG. 2 is an end perspective view of a partially assembled PV array using the PV module support system.

FIG. 3 is a detailed view of the PV array of FIG. 2.

FIG. 4A is partial elevational end view of a joining rail securing together PV modules.

FIG. 4B is partial elevational end view of a joining rail securing together PV modules is a faceted manner.

FIG. 5A is a partial elevational end view of a joining rail positioned on a perimeter of an array.

FIG. 5B is a partial elevational end view of an alternative embodiment of a joining rail positioned on an edge of a perimeter of an array

FIG. 5C is an exploded view of FIG. 5B showing an electrical connector on a PV module.

FIG. 5D is an end view of joined modules using the joining rail of FIGS. 5A and B.

FIG. 6 is a detailed perspective bottom view of a joining rail securing together PV modules.

FIG. 7 is a cross-sectional view of a first frame member.

FIG. 8 is a cross-sectional view of a second frame member.

FIG. 9 is an exploded elevational view of a PV array showing various PV modules with different frame configurations.

### DETAILED DESCRIPTION

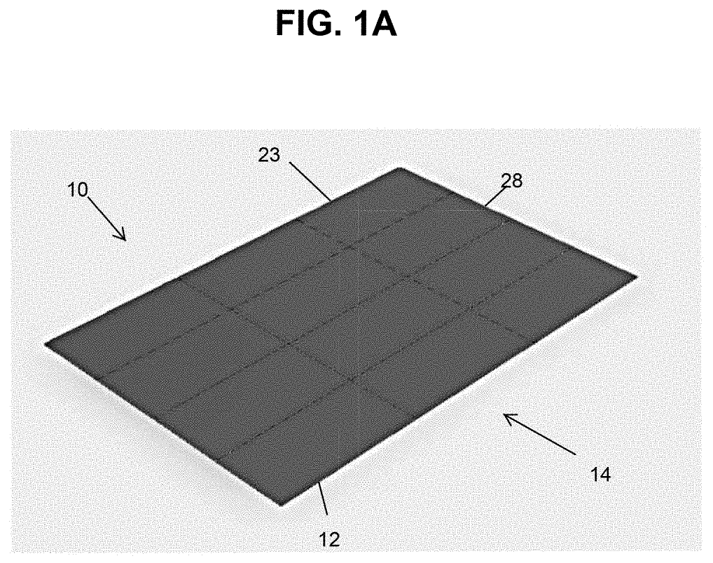

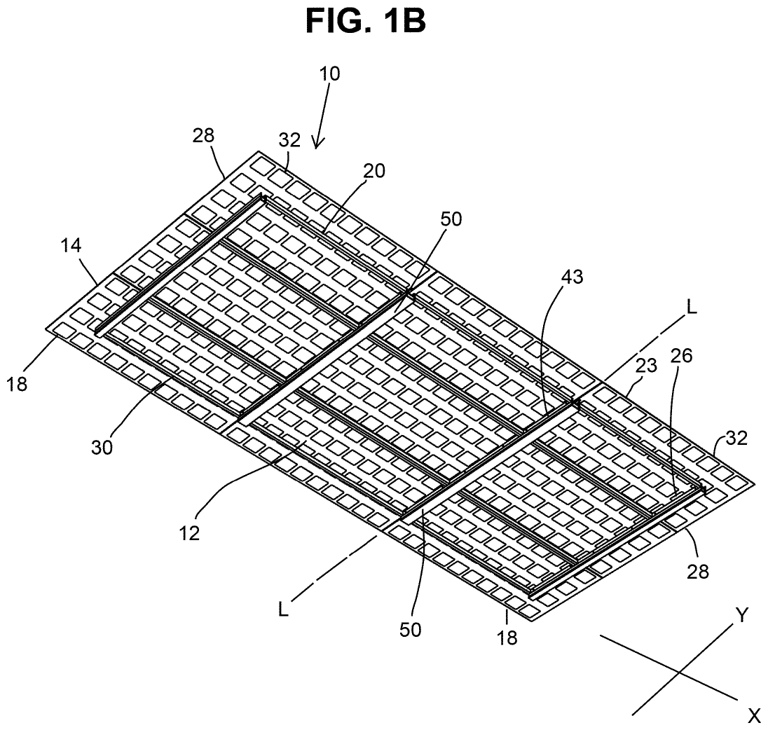

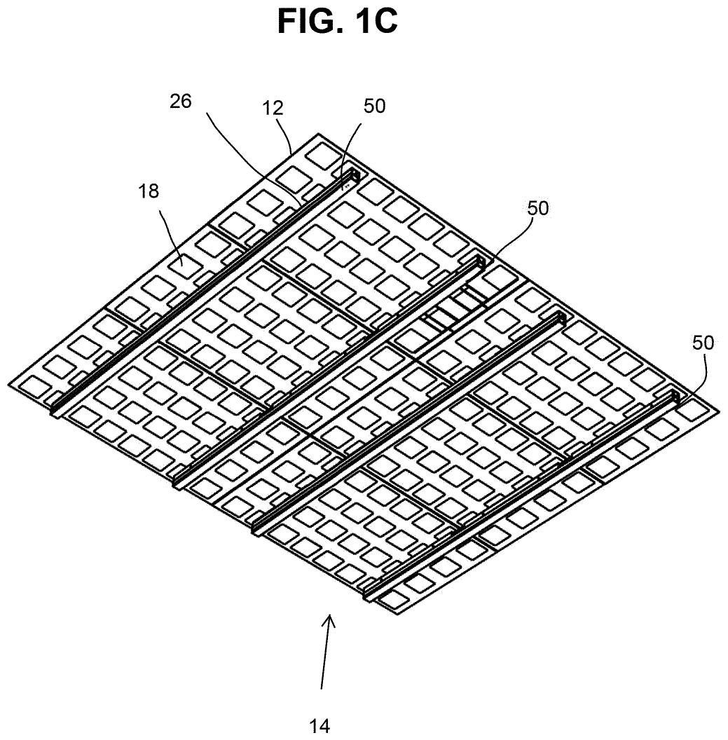

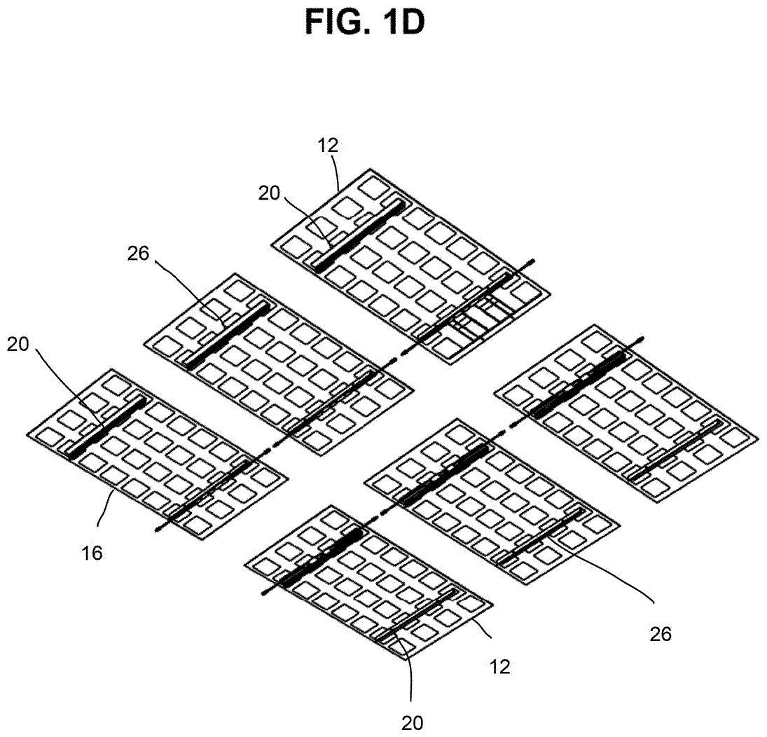

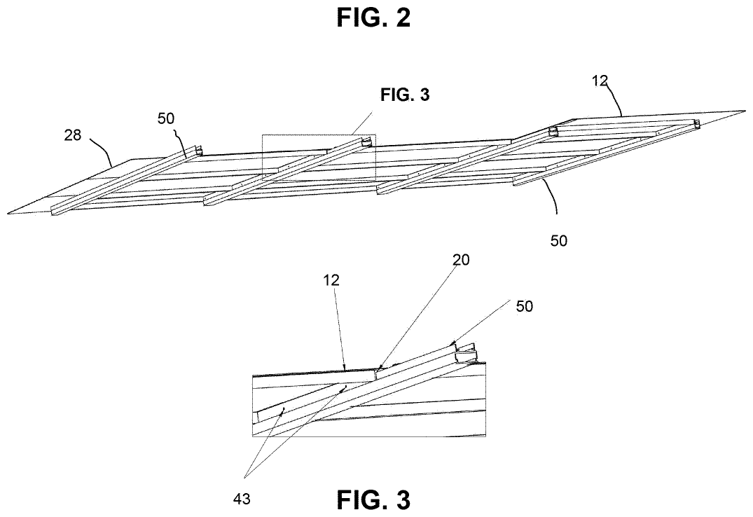

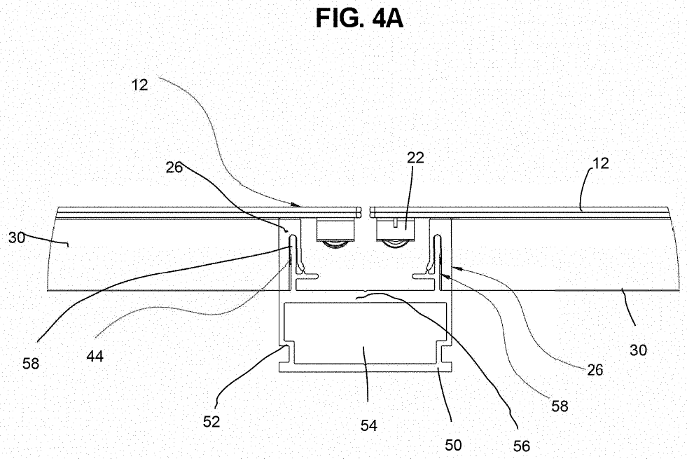

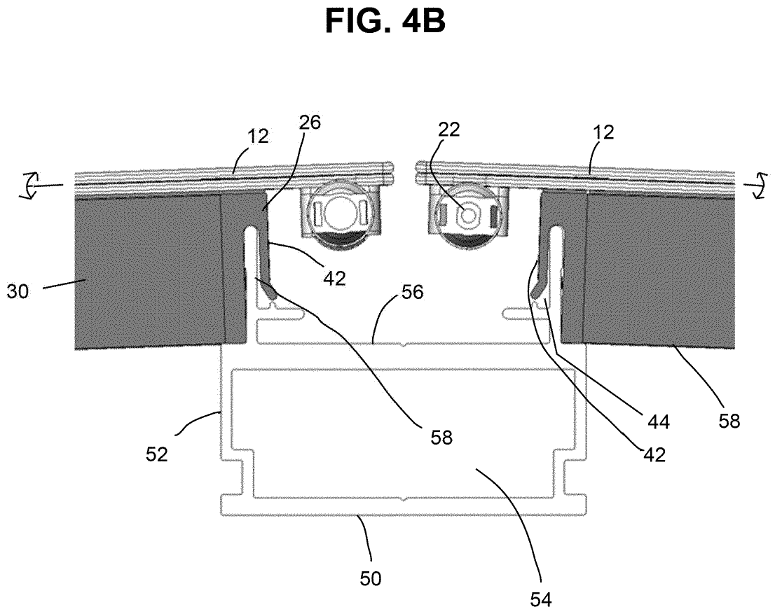

A photovoltaic (“PV”) module system 10 is shown in FIGS. 1A and 1B to 4. The system 10 provides a support for a plurality of PV modules 12, and facilitates ease of mounting and alignment of the PV modules 12 in a PV array 14. The PV array 14 has an X and Y orthogonal axis. PV modules 12 are formed of a PV panel 16 having a plurality of solar cells 18 for converting sunlight into electricity. Each PV module 12 has a panel frame 20 secured to the underside of the PV panel 16 to facilitate support and mounting thereof. A junction box 22, FIG. 4A, or other electrical connection device may also be located on the underside of the PV panel 16 to permit the PV modules 12 to be wired together in a manner known in the art. The PV array 14 may have a continuous edge 23 of cantilevered PV panels around the full perimeter of the array. The PV array 14 may form a portion of a structure such as a roof or awning. The PV module system 10 permits for a continuous top surface, see FIG. 1, in which frames or other protrusions are not visible and further permits collection and/or diversion of rainwater.

The panel frame 20 includes a plurality of rigid frame members secured to the undersurface of the PV panel. In one embodiment, the panel frame 20 may be joined to the panel 16 via an adhesive. The frame members may be formed of material such as aluminum or galvanized steel. The panel frame 20 may have a rectangular configuration to generally match the configuration of the PV panel 16. However, it is contemplated that the panel frame 20 may have differing configurations. Each panel frame 20 includes a pair of spaced first members 26 extending along, and parallel to, the short side 28 of the PV panel. The frame 20 may further included a pair of spaced second members 30 extending along, and parallel to, the long side 32 of the PV panel. The pair of first members 26 are joined end-to-end to the pair of second members 30 forming a rectangular frame 20. The manner of joining the first and second members together may include mechanical fasteners, welding or adhesives.

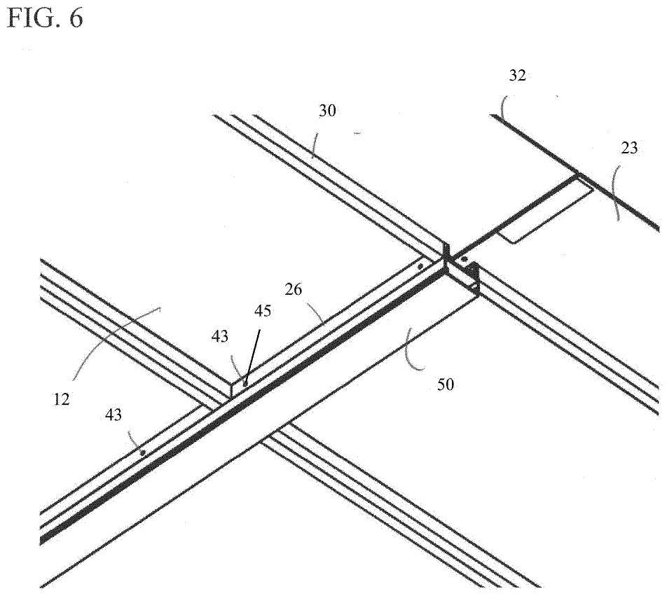

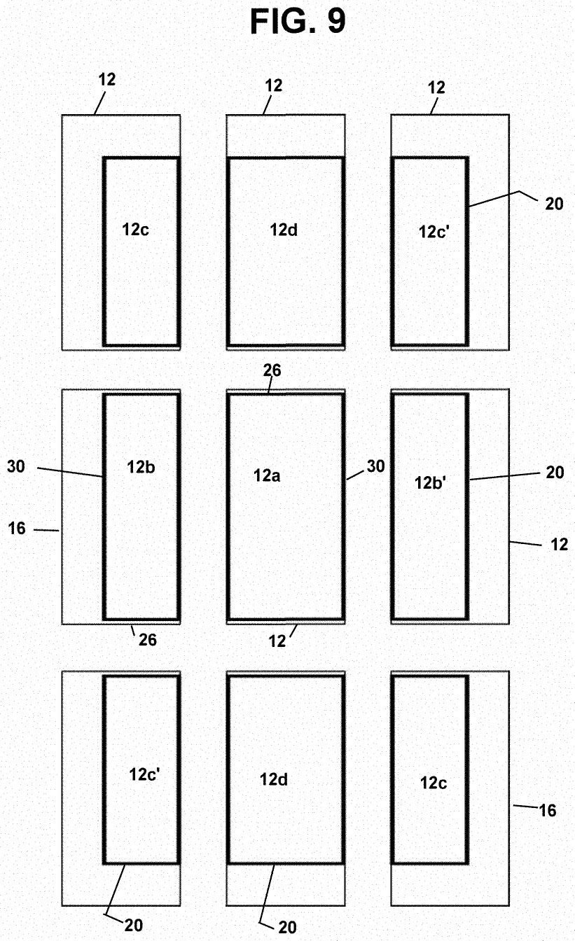

With reference to FIGS. 6 and 8, the pair of second members 30 may be similarly formed and have wall 34 with a square or rectangular cross-sectional configuration with a hollow center 36. A fastener securement element 38 may project inwardly from a wall 34 to permit a fastener to secure a first frame member 26 to a second frame member 30.

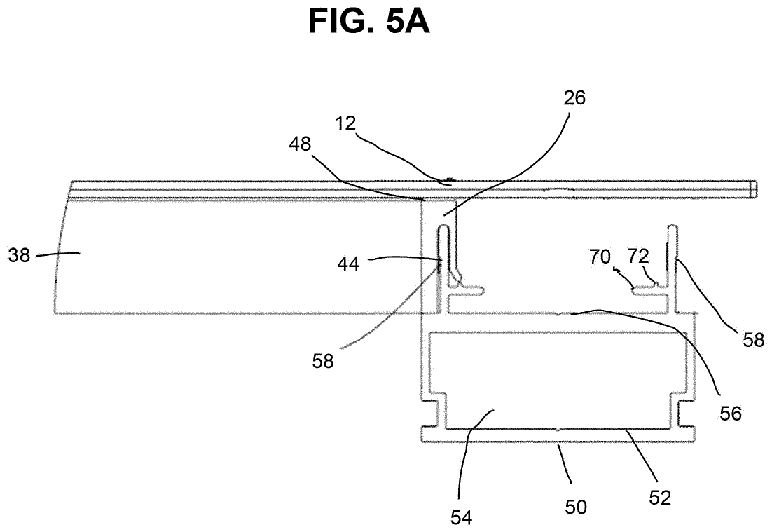

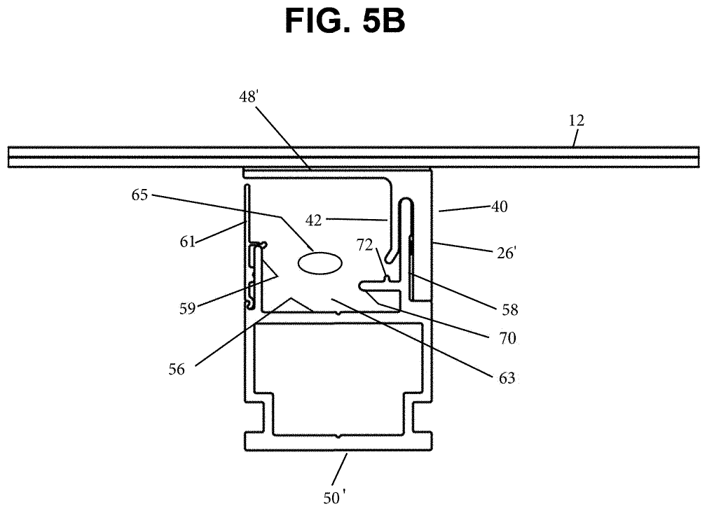

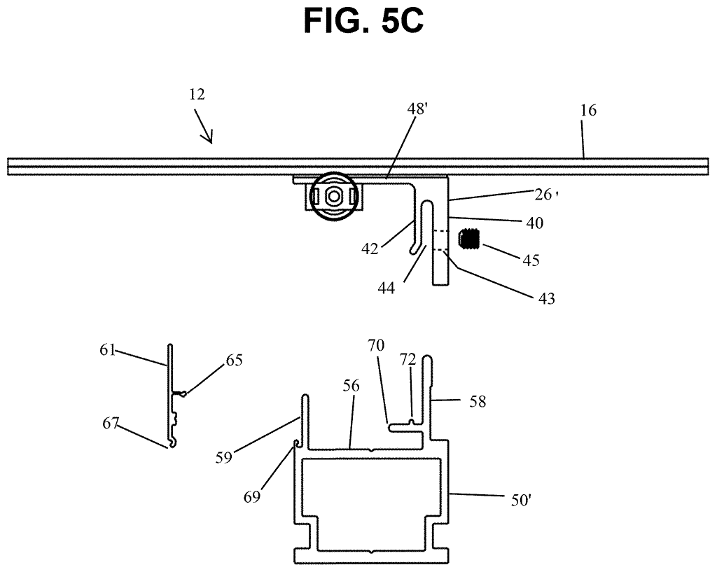

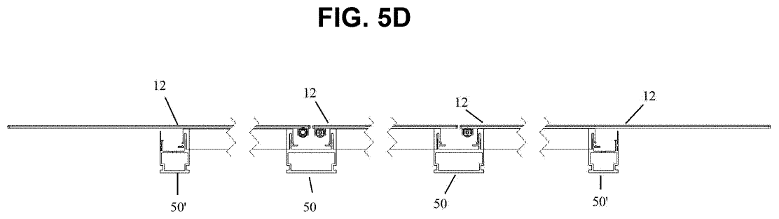

With reference to FIGS. 4A-5 and 7, the pair of first members 26 are each similarly formed and have a body with generally U-shaped configuration with a first and second spaced and opposed legs 40, 42. The legs 40, 42 define therebetween an elongate slot 44 extending along the length of the first frame member 26. The second leg 42 may be shorter and thinner than the first leg 40 and end in an outwardly turned lip 46. The first leg 40 includes a plurality of longitudinally spaced threaded through holes 43. The through holes 43 accept fasteners 45 that can be advanced into the slot 44 for securing together the PV modules 14 of the array as described below. The fasteners 45 each travel between a secured position and a release position along an axis parallel to a surface formed by the plurality of PV modules as shown, for example, in FIG. 5C. This permits each of operating the fasteners to permit one to install and adjust the PV modules. The first frame members 26 each have a planar mounting surface 48, which is attached to the undersurface of the PV panel 16, such as by adhesive.

In the alternative embodiment shown in FIGS. 5B and C, the mounting surface 48′ of the first frame member 26′, extends outwardly beyond the second leg 42 to provide increased mounting surface area to secure the frame to the PV panel 16.

With reference to FIGS. 4A-6, PV modules 12 may be connected together by joining rails 50, which extends along the frame first members 26 of adjacent PV modules. The joining rails 50 may be rigid members formed, for example, of aluminum or steel. The joining rails 50 secure the PV modules 12 together preventing movement in both the X and Y axis of the PV array 14. The joining rail 50 includes a central body 52 defining an enclosed channel 54 open at its ends. The body 52 has a first planar surface 56 from which a pair of spaced walls 58 project. The walls 58 extend along the longitudinal axis L of the joining rail. For illustration purposes the longitudinal axis L extends in the Y axis of the array shown in FIG. 1B. As shown in FIGS. 5A and 5C, the rail walls 58 may also each include a ledge 70 projecting from, and extending along, the length thereof. The ledges 70 extend toward each other into the space between the walls. The ledge may include a raised rib 72 extending along its length. The ledges may be used for mounting and electrically bonding power electronics, such as rapid shutdown devices.

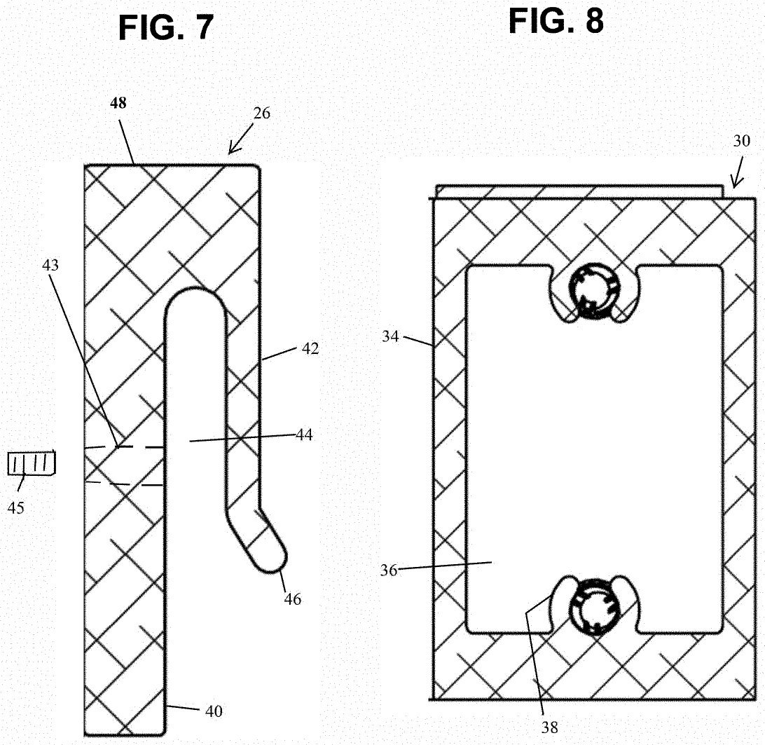

The PV modules 12 can be slid onto the joining rails 50 with the walls 58 sized to extend into the slots 44 of the first members 26 of adjacent PV modules 12. When inserted into the slots 44, the walls 58 are captured between the first and second legs 40 and 42. The lip 46 permits the joining rail wall 58 to be easily inserted into the slot 44. The engagement of the walls 58 in the slots 44 prevents the adjacent PV modules from moving relative to each other in a direction perpendicular to the longitudinal axis L of the joining rail 50. However, the joined PV modules 12 may still be movably adjusted with respect to each other in a direction parallel to the longitudinal axis L of the joining rail 50. When the PV modules 12 are properly aligned, a plurality of fasteners 45 are inserted into the through holes 43 formed along the length of the first members 26, see FIGS. 6 and 7. The fastener 45 may be a setscrew or similar threaded device. As the fasteners 45 are tightened, the joining rail walls 58 are clamped against the second leg 42 and positionally fixed and secured in the slots 44. This prevents movement of the PV modules 14 along a direction parallel to the longitudinal axis L-L of the joining rail. The fastener 45 also electrically bonds the frame 20 to the joining rail 50. A plurality of joining rails 50 may be used to join together a plurality of PV modules as shown in FIG. 1C. Therefore, with the fasteners 45 secured, the joined PV modules 12 are fixedly secured together as in an array. Should separation or realignment of the PV modules 12 be desired, the fasteners 45 can be loosened, the PV module or modules adjusted, and then the fasteners can be retightened as needed. The manner in which the PV modules 14 are secured to the joining rails 50 allows for attachment of the PV modules to the joining rails from below the array. This is desirable if the PV array 14 is forming a cover or roof of a structure and the PV array under surface is exposed.

The connection between the frame 20 and the joining rails 50 electrically bonds the PV modules and all the frames 20 and joining rails 50 together to facilitate proper grounding of the PV array 14.

When PV modules 12 are joined short end to short end as shown in FIG. 1, both joining rail walls 58 are used to secure PV modules 12 together. However, joining rails positioned along an end of an array use only one wall 58 to secure PV modules along the longitudinal axis L of the rail, i.e., along the Y axis shown in FIG. 1. The other wall 58 would remain unengaged to any PV module as shown in FIG. 5A.

In alternative embodiment, the joining rail 50′ may only include a single rail wall 58. This would be used as an edge joining rail as shown in FIGS. 5B and C. The edge joining rail 50′ has a single rail wall 58 extending from the planar surface 56. In place of the other wall is a flange 59 that also extends from the planar surface but is shorted than wall 58. A removable side cover 61 clips on to the flange 59 forming a wire way 63. The cover 61 extends along the entire length of the rail 50′. The cover 61 can be removed to provide access to wires 65 during PV module installation and then replaced to conceal the wires once the installation is complete. With particular reference to FIG. 5C, the cover has a projection 66 extending outwardly therefrom which clips over the end of flange 59. The cover 61 has a curved bottom lip 67 that cooperate with a notch 69 formed along the length of the rail adjacent the surface 56 to removably secure the cover 61 to the rail 50′.

With reference to FIGS. 1C and D, it is contemplated that the frame 20 can be formed without the second frame members 30. In applications where the PV panel 16 is sturdy enough and/or the mounting location and environmental factors permit, the extra support is not required. The second frame members 30 are used for supporting the PV panel 16 and are not employed in joining the PV modules 12 together. The joining rails 50 are used to engage the first frame members 26 in a similar manner to that described above. Therefore, the manner in which the joining rails 50 secure the PV modules 12 together to form and array is the same. In such applications, the first frame members may be formed as first frame members 26′ having an extended mounting surface 48″ that engages and is secured to the PV panel 16 as shown in FIG. 5C. This provides more surface area to secure the first frame member 26′ to the PV panel 16.

The solar panel array 14 includes a plurality of connected PV modules 12. While each PV module 12 is generally formed as described above, the PV modules may differ as to the location of the frame 30 on the PV panel 16. As shown in FIG. 1B, the array of panels in the system has a generally uniform overhang of PV panel beyond the frame on all edges of the solar panel array. This is achieved by having seven separate PV module configurations. With reference to FIG. 9, a first module configuration 12a has the first and second frame members 26 and 30 running along the outer edges of the PV panel. There is no significant overhang or cantilevered portion of the PV panel extending beyond the frame on any side of the PV panel. PV modules 12 with this configuration are used for the internal PV modules 12a in an array. This permits the PV modules to be joined with edges closely positioned next to each other or touching.

A second PV module configuration 12b, shown in FIG. 9, is configured for location along a non-corner perimeter of the PV array. The frame 20 is offset from only one long edge of the PV panel. The offset results in a cantilevered overhang along one side. The frame runs along the other edges of the PV panel. This configuration can be for a left side 12b or right side 12b′.

A third PV module configuration 12c, is a corner PV module. The frame is offset from both a long edge and a short edge of the PV panel. The offset results in a cantilevered overhang along two adjacent sides of the PV panel. The frame runs along the other edges of the PV panel. This configuration can be for a left side 12c or right side 12c′.

A fourth PV module 12d is a non-corner PV module with the frame offset from one short edge of the PV panel. The offset results in a cantilevered overhang along one short side of the PV panel. The reminder of the frame members are disposed adjacent the remaining edges of the PV panel. With the number of PV modules and their left/right variations, a panel array of varying sizes can be formed.

The manner in which the PV modules 12 are secured to the joining rails 50, permits individual PV modules 12 to be removed and replaced, without having to disturb the other PV modules in the array 14. The fasteners 58 can be loosed and the PV module can be lifted away from the joining rails 58. A new PV module can them be inserted into the array and the fasteners 58 tightened. In addition, the system 10 allows for different gaps between PV modules to be created. For example, a space may be left between the long edges of the PV modules when assembling an array to create gaps between the rows of PV modules. If is also contemplated that joining rails 50 could be formed having spacing between the walls 58 that create a gap between the short edges of the PV modules.

With reference to FIG. 4B, the system 10 also allows the top plane of PV modules on a shared joining rail 50 to articulate for faceted array installations. This is achieved by creating a frame slot 44 having a width greater than a thickness of the rail wall 58. This creates a clearance between the wall 58 and the slot 44 such that the PV modules can pivot relative to the joining rails 50. This permits the PV modules to be fastened wherein the walls of the frame 42 and 40 are not parallel to the rail wall 58. Accordingly, the top surfaces of the PV modules will also not be parallel so the array can be faceted to simulate an arc or other curved shape.

While the above disclosure has been shown a system 10 for joining and supporting PV modules 12 including photocells 18, it is contemplated that the system can be used to join and support panels other than PV modules. For example, non-functional PV panels that have no photocells or panels formed of common construction material such as wood, glass, metal or composite could be secured using the disclosed system.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

What is claimed is:

1. A photovoltaic (“PV”) module support system comprising:
a first PV module having a first PV panel adapted to generate electrical energy from sunlight, the first PV panel having an upper surface and a lower surface and a first frame secured to the lower surface of the first PV panel, the first frame having a pair of first frame members each including an elongate slot; and
a first joining rail having a body and a first wall projecting outwardly from the body, the first wall inserted within the elongate slot of one of the pair of the first frame members, a fastener connected to the one of the pair of first frame members and movable to clamp the wall within the slot, wherein the first PV module is positionally fixed relative to the joining rail.

2. The system as defined in claim 1, including a second PV module having a PV panel adapted to generate electrical energy from sunlight, the second PV panel having an upper surface and a lower surface, a second frame being secured to the lower surface of the second PV panel, the second frame having a first second frame member including an elongate slot, the first joining rail having a second wall projecting outwardly from the body, the second wall being inserted within the elongate slot of the first member, wherein the second PV module is positionally fixed relative to the joining rail, and wherein the first joining rail secures the first PV modules to the second PV module together.

3. The system as defined in claim 1, wherein the first frame member includes a first and second spaced legs forming the slot therebetween, the first leg having a through hole to threadedly accommodate the fastener, and the fastener being movable into the slot to engage the joining rail.

4. The system as defined in claim 1, wherein the first frame is offset from at least one of the edges of the PV panel forming a cantilevered overhang along one edge of the PV panel.

5. The system as defined in claim 4, wherein the frame is offset from at least two of the edges of the PV panel forming a cantilevered overhang along two edges of the PV panel.

6. The system as defined in claim 1, wherein the first frame and first joining rail are in electrical communication with each other.

7. The system as defined in claim 2, wherein the first PV panel and the second PV panel have the same configuration and the first frame on the first PV panel is disposed on the first PV panel such that the first frame is offset from only one edge of the first PV panel and the second frame on the second PV panel is offset from two edges of the second PV panel.

8. The system as defined in claim 1, wherein the first joining rail first wall inserted within the elongate slot of the first member has a thickness less than a width of the slot wherein the first PV module can pivot relative to the first joining rail.

9. The system as defined in claim 1, including a second joining rail having a body and a wall projecting outwardly from the body, the wall being insertable within the elongate slot of the other of the pair of first frame members

10. The system as defined in claim 1, wherein the first frame includes a pair of second frame members extending between, and joined to, the pair of first frame members.

11. A photovoltaic (“PV”) module array comprising:
a first and a second PV module each including a PV panel for generating electricity and a frame secured to an undersurface thereof, the frame of the first and a second PV module including a slot extending along a portion thereof;
an elongate first joining rail for securing the first and a second PV module together; the first joining rail including a pair of spaced walls extending along a length thereof; a first of the pair of walls being inserted in a slot in the frame of a first PV module and the second of the pair of walls being inserted in a slot in the frame of a second PV module, the first and second PV modules being slidable on the joining rail in an unsecured state, a plurality of fasteners engageable with the frame and the joining rail, the plurality of fasteners movable to a securing position to secure the first and second PV modules relative to the joining rail wherein the position of the first and second PV modules are fixed.

12. The array as defined in claim 11, including a third PV module including a PV panel for generating electricity and a frame secured to an undersurface thereof, the frame including a slot extending along a portion thereof, the first of the pair of walls being inserted in the slot in the frame of a third PV module to secure the third PV module to the first joining rail.

13. The array as defined in claim 12, including an elongate second joining rail including a single wall extending along a length thereof, the single wall being insertable into a slot of one of the frames of the first, second and third PV modules.

14. The array as defined in claim 12, further including a fourth PV module including a PV panel for generating electricity and a frame secured to an undersurface thereof, wherein the frame of the first, second, third, and fourth PV modules is disposed at a different location than the others.

15. The array as defined in claim 12, wherein the first PV module frame includes members running adjacent to two side edges of the first PV module and offset from two other edges of the first PV module, and the second PV module frame includes frame members running adjacent three sides of the second PV module and offset from one edge of the second PV module, and the third PV module frame includes frame members running adjacent four sides of the third PV module and offset from none of the edges of the third PV module.

16. A method of installing a photovoltaic (“PV”) module array comprising:
obtaining a plurality of PV modules each including an electricity producing PV panel having a frame secured to an underside thereof;
obtaining a joining rail having a first and second spaced walls projecting outwardly from a rail;
sliding a first of the plurality of PV modules onto the first wall of the joining rail and sliding a second of the plurality of PV modules onto the second wall of the joining rail;
operating a first fastener disposed on the first PV module frame to clamp the joining rail first wall to the frame wherein the position of the first PV module is fixed; and
operating a second fastener disposed on the second PV module frame to clamp the joining rail second wall to the frame wherein the position of the second PV module is fixed.

17. The method as defined in claim 13, wherein the first and second fasteners each travel between a secured position and a release position along an axis parallel to a surface formed by the plurality of PV modules.

18. A panel joining and support system comprising:
a first panel having an upper surface and a lower surface a frame secured to the lower surface of the first panel, the frame having a first frame member including an elongate slot running along a length of the first frame member; and
a joining rail having a body and a first wall projecting outwardly from the body, the first wall inserted within the elongate slot of the first member, a fastener connected to the first frame member and movable to clamp the wall within the slot, wherein the first panel is positionally fixed relative to the joining rail.

19. The system as defined in claim 18 wherein the first frame member includes a first and second spaced legs forming the slot therebetween, the first leg having a through hole to threadedly accommodate the fastener, the fastener movable into the slot.

20. The system as defined in claim 19, including a second panel having an upper surface and a lower surface and a second frame secured to the lower surface of the second panel, the second frame having a first frame member including an elongate slot running along a length thereof, and wherein the joining rail has a second wall projecting outwardly from the body, the second wall being inserted within the elongate slot of the first second frame member, wherein the joining rail secures the first panel to the second panel.

21. The system as defined in claim 20 wherein the first panel and second panel each include a plurality of solar cells for generating electricity.
